(19) United States
(12) Patent Application Publication
(10) Pub. No.: US 2024/0047803 A1
(43) Pub. Date: Feb. 8, 2024

(54) COVERING ARTICLE, BATTERY PACK CONTAINING THE SAME AND THE PROCESS FOR PREPARING THE BATTERY PACK

(71) Applicant: BASF SE, Ludwigshafen (DE)

(72) Inventors: Yan Gang MA, Shanghai (CN); Lei SUN, Shanghai (CN); Andrew C. SHUM, Singapore (SG)

(73) Assignee: BASF SE, Ludwigshafen (DE)

(21) Appl. No.: 18/258,409

(22) PCT Filed: Dec. 10, 2021
(86) PCT No.: PCT/EP2021/085215

§ 371 Date: Jun. 20, 2023

(30) Foreign Application Priority Data
Dec. 28, 2020 (WO) PCT/CN2020/140194

(51) Int. Cl. H01M 50/231; H01M 50/227; H01M 50/224; H01M 50/236; H01M 50/242; B29C 39/12; B29C 45/14

(52) U.S. Cl. CPC H01M 50/231; H01M 50/227; H01M 50/224; H01M 50/236; H01M 50/242; B29C 39/123; B29C 45/14508; H01M 50/249

(57) ABSTRACT

Disclosed herein are a 3D shape covering article including a reaction injection molded product as core layer and two metal sheets located on both sides of the core layer, a battery pack including the covering article, and a process for preparing the battery pack.

### TECHNICAL FIELD

The present invention relates to a novel covering article, battery pack containing the same and the process for preparing the battery pack. Said battery pack comprises upper cover, which is a reaction injection molded (RIM) product; and bottom tray, which comprises a reaction injection molded product as core layer and two metal face sheets located on both sides of the core layer.

### BACKGROUND

With the development of electric vehicles, more and more attention has been paid to the lightweight design and capacity limits of battery. At present, people mainly use stamped metal sheet as the upper cover and the bottom tray of battery pack to protect battery components therein. Although metal materials show good mechanical properties, their density and hence component weight is high, so it is urgent to provide a new lightweight component to replace the metal housing.

Sandwich component consists of face sheets, intermediate core layer and adhesive layers to bond the core layer with face sheets. Sandwich is widely used in aerospace sector due to its high strength/weight ratio. The face sheets include metals like steel, aluminum alloy, and composite plate reinforced by carbon fiber, glass fiber, aramid fiber, or basalt fiber etc. The core layer materials include foamed or compact polymers, honeycomb and micro-truss. For example, US2019/0153185A1 disclosed a sandwich component constructed in a flat form and its use as non-loading-bearing wall elements, exterior wall cladding, and ceiling elements; nevertheless, it fails to disclose or suggest that this sandwich component can be used as bottom tray of battery pack. For bottom tray of battery pack, particular properties such as mechanical strength and flame resistance need to be met, and also there is a need for curved or even patterned component shape to meet the complex contour of battery.

The prior art discloses injection molding part based on polypropylene or polyamide as the upper cover of battery pack. However, it is difficult for such polypropylene or polyamide material injection molding solution to realize a very large size component such as the upper cover; the injection molding thereof requires high tooling cost, high pressure and temperature. Up to now, there is no publication or patent disclosing or suggesting that reaction injection molded (RIM) product, such as polyurethane, can be used as battery upper cover.

Therefore, it is still required to provide a novel 3D shape covering article that has light weight and, at the same time, good mechanical strength and flame resistance.

### BRIEF DESCRIPTION OF THE FIGURES

FIG. 1 shows the upper cover and bottom tray for battery pack, wherein the upper cover is based on polyurethane, the bottom tray comprises polyurethane core layer and two metal face sheets located on both sides of the polyurethane core layer.

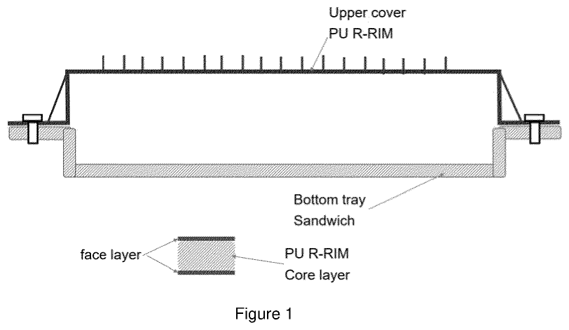

FIG. 2 is a single-step process to produce 3D shape sandwich part.

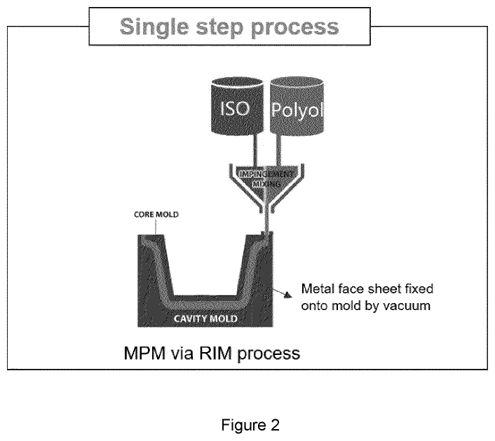

FIGS. 3-4 show the upper cover having rib pattern design, optimized thickness distribution and recommended rib pattern.

FIGS. 5-6 show the structure of bottom tray, the detail of inner plate thereof and bending/welding process.

FIG. 7 shows the sealing design for flange.

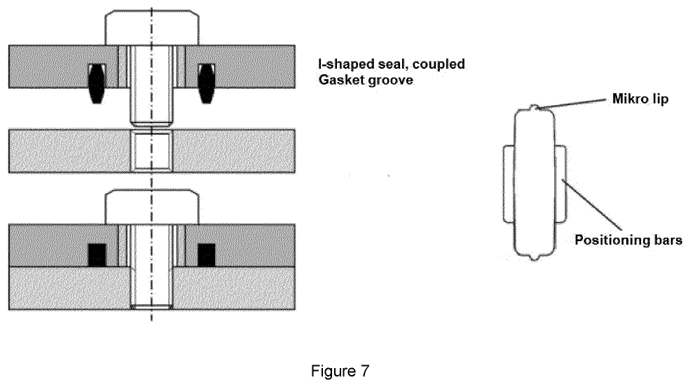

### SUMMARY OF THE PRESENT INVENTION

An object of this invention is to overcome the problem of the prior art discussed above and to provide a novel manufacturing process and structure of battery pack that has light weight and, at the same time, good mechanical strength and flame resistance.

Surprisingly, it has been found by the inventors that the above object can be achieved by a covering article contains a reaction injection molded product as core layer and two metal sheets located on both sides of the core layer, wherein the covering article is a 3D shape article.

In a further aspect, the invention relates to a battery pack, comprising upper cover; bottom tray, wherein the bottom tray is the covering article as described above.

In a still further aspect, the invention relates to a process for producing the battery pack according to the invention, comprising the following steps:
providing upper cover via reaction injection molding (RIM process), and
providing bottom tray, comprising the steps of
1) bending flat metal sheets into target 3D shape top and bottom metal face sheets and welding at the open corner;
2) fixing the top and bottom metal face sheets into a RIM mold, and then closing the mold;
3) injecting the reactants into the hollow space cavity between metal face sheets to form molded core layer via reaction injection molding (RIM process);
4) demolding and optionally trimming.

It has been surprisingly found in this application that, battery pack containing the covering article based on reaction injection molded (RIM) product shows reduced weight, and, at the same time, good mechanical strength and flame resistance.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the expression “comprising” also encompassed the expression “consisting of”.

Unless otherwise identified, all percentages (%) are “percent by weight”.

Unless otherwise identified, the temperature refers to room temperature and the pressure refers to ambient pressure.

Covering Article

In one aspect, the present invention provides a covering article contains a reaction injection molded product as core layer and two metal sheets located on both sides of the core layer, wherein the covering article is a 3D shape article.

Reaction injection molding (RIM) is a process involving pressurized mixing of two or more reactive, low-viscosity liquids followed by injection into a mold cavity and polymerization to set a part's shape in minutes or even seconds. RIM can achieve effective mixing of reagents by increasing the velocity of impinging streams. The relatively low pressure and temperature requirements for RIM translate to lower tooling cost, and RIM can successfully mold complex parts with high resolution features containing thick and thin walls. The reaction injection molded product is selected from the group consisting of polyurethane, polyamide, unsaturated polyester resin, epoxy resin, phenol-formaldehyde resin, preferably polyurethane.

In the present invention, the covering article is prepared by the following steps: 1) bending flat metal sheets into target 3D shape top and bottom metal face sheets and welding at the open corner; 2) fixing top and bottom metal face sheets into a RIM mold; 3) injecting the reactants into the hollow space cavity between metal face sheets to form molded core layer via reaction injection molding (RIM); 4) demolding and optionally trimming.

The metal face sheets are same or different material selected among aluminum alloy, iron, steel, aluminum. The metal face sheets have a thickness between 0.08 and 0.6 mm, preferably between 0.12 and 0.4 mm, more preferably between 0.2 and 0.3 mm. Preferably, the metal face sheets have four sides bent at a certain angle, preferably from 80° to 100°, more preferably 90°, and then the open corners are joined by welding, preferably by argon arc welding. The curvature radius of bending angle is in the range from 0 to 10 mm, preferably from 2 to 5 mm. The core layer has a thickness between 0.8 and 5 mm, preferably between 2 and 3 mm; the core layer has a density between 600 and 2000 kg/m³, preferably between 900 and 1300 kg/m³, more preferably between 900 and 1100 kg/m³.

The covering article according to the invention can be used as bottom tray of a battery pack.

Battery Pack

In one aspect, the present invention provides a battery pack, comprising
upper cover;
bottom tray, wherein the bottom tray is the covering article according to the invention.

The upper cover is a reaction injection molded (RIM) product selected from the group consisting of polyurethane, polyamide, unsaturated polyester resin, epoxy resin, phenol-formaldehyde resin, preferably polyurethane. Reaction injection molding (RIM) process can easily realize complex (especially deep) rib pattern design. In the present invention, the upper cover is provided with rib pattern to improve parts stiffness. Thus, it is possible to reduce the weight of the upper cover and simultaneously maintain the mechanical property thereof.

In the present invention, the upper cover can be provided with a plurality of longitudinal stiffening ribs and transverse stiffening ribs that can cross each other. In an embodiment, the upper cover is provided with a regular rib pattern. In a preferable embodiment, the upper cover is provided with an irregular rib pattern. In the present invention, the rib height is in the range from 3 mm to 30 mm, preferably 3 mm to 8 mm.

By way of example, CAE (Computer Aided Engineering) systems may be utilized for the design of rib pattern, based on the shape parameters on CAE models of moldings including but not limited to rib height change, rib thickness change, rib orientation change, rib location change, and the like. According to pre-set rules, the computer Aided Engineering system may more efficiently analyze and allow adjustment of various features of the models of moldings. For example, a rib exhibiting high stress may be thickened.

It is known that the battery is usually installed on or near vehicle chassis and thus it is necessary to protect the battery from outer force. According to the invention, the metal sheet of the bottom tray has wavy surface to protect penetration from outer force. The orthogonal deflection is to transform dangerous Z-axis incoming energy into safe perpendicular XY energy. The loss in amount of energy is the energy lost to deforming the steel & PU.

In the present invention, the total thickness of upper cover is in the range from 1 to 5 mm, preferably from 1.5 to 4 mm, more preferably from 2 to 3 mm; the total thickness of bottom tray is in the range from 1 to 5 mm, preferably from 1.5 to 4 mm, more preferably from 2 to 3 mm.

Flat gasket and sealing design is suitable for metal housing, not suitable for plastic. According to the invention, the upper cover and the bottom tray are preferably sealed with groove on flange, and vertical oval shape gasket located in the groove. It will be understood that the groove will be required to correspond to the shape of the gasket so that the gasket can be partly received in the groove, when in use. When the screws are tightened to secure the upper cover and the bottom tray together, the gasket is compressed within the groove to form a seal there-between. This sealing design shows better sealing performance and is critical for the water tightness of battery pack.

The use of an oval, obround or elongated gasket may be particularly advantageous. The gasket material is selected from the group consisting of polyurethane foam, ethylene acrylic elastomer (AEM), acrylate material (ACM), nitrile butadiene rubber (NBR), fluorocarbon rubber (FPM), ethylene propylene diene rubber (EPDM), hydrogenated acrylonitrile butadiene rubber (HNBR), methyl-vinyl silicone rubber (MVQ), silicone and fluorosilicone, preferably AEM elastomer having a Shore A hardness of from 45 to 60. Preferably, micro lips are on both top and bottom side of gasket to further concentrate gasket surface pressure and minimize the reaction force to flange.

In the present invention, the depth of the groove is in the range from 5 mm to 10 mm, preferably from 6 to 7 mm, and the width of the groove is in the range from 2 mm to 5 mm, preferably from 3 to 4 mm.

RIM has been most frequently employed to prepare thermoset polyurethane (PU) networks by reacting liquid polyol and polyisocyanates to form urethane linkages. Also, RIM can be employed to prepare polyamide (PA), unsaturated polyester resin (UPR), epoxy resin, phenol-formaldehyde resin, etc., provided that the viscosity range of their reactants is suitable for RIM process. In the present invention, the reaction injection molded (RIM) product is selected from the group consisting of polyurethane (PU), polyamide (PA), unsaturated polyester resin (UPR), epoxy resin, phenol-formaldehyde resin, preferably polyurethane.

Polyurethane

In preparing a polyurethane upper cover or polyurethane core layer of bottom tray, “isocyanate component” and “resin components” are used, with “resin components” being a mixture of the substance reactive toward isocyanate (b), optionally chain extenders and/or crosslinking agents (c), flame retardants (d), filler (e), blowing agents (f), catalysts (g), and optionally auxiliaries and additives (h), and “isocyanate component” being isocyanates (a). The polyol components react with the isocyanate to form urethane linkages. Such systems are disclosed, for example, in U.S. Pat. No. 4,218,543.

The “isocyanate component” and “resin component” are impingement mixed at pressures around 2,000 psi and injected at about atmospheric pressure into a mold which is subsequently shut. The mold is preheated at from 40° C. to 65° C., preferably from 50° C. to 55° C., and may contain an insert such as metal sheet on the mold surface. The raw material is usually center injected, after which the part is demolded after a period of typically one to four minutes.

Isocyanate Component (a)

Isocyanates (a) used for producing the polyurethanes of the invention comprise all isocyanates known for producing polyurethanes. These comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate. Particular preference is given to using 2,2′-, 2,4′- and/or 4,4′-diisocyanate, and polymeric MDI.

Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

Component (b)

Substance reactive toward isocyanate (b) can be any of the compounds used for polyurethane production in the art and having at least two reactive hydrogen atoms. By way of example, it is possible to use polyether polyamines and/or polyols selected from the group of the polyether polyols and polyester polyols, or a mixture thereof.

The polyols preferably used are polyether polyols with a molecular weight between 500 and 6000, preferably from 2000 to 5000, more preferably from 2500 to 3500, OH value between 20 and 200 mg KOH/g, preferably from 30 to 100 mg KOH/g, and/or polyester polyols with molecular weights between 350 and 2000, preferably from 350 to 650, OH value between 60 and 650 mg KOH/g, preferably from 120 to 310 mg KOH/g. The following polyols are preferred in the invention: LUPRANOL® 2095 (BASF), LUPRANOL® 2090 (BASF), LUPRAPHEN® 3905 (BASF), LUPRAPHEN® 3907 (BASF), LUPRAPHEN® 3909 (BASF), STEPANPOL® PS 3152, PS 2412, PS 1752, CF 6925 (Stepan Company).

The polyether polyols that can be used in the invention are produced by known processes. By way of example, they can be produced from one or more alkylene oxides having from 2 to 4 carbon atoms in the alkylene radical via anionic polymerization using alkali metal hydroxides, such as sodium hydroxide or potassium hydroxide, or using alkali metal alcoholates, such as sodium methoxide, sodium ethoxide or potassium ethoxide, or potassium propoxide as catalysts, with addition of at least one starter molecule which comprises from 2 to 8 reactive hydrogen atoms, or via cationic polymerization using Lewis acids, such as antimony pentachloride, boron fluoride etherate, etc., or bleaching earth as catalysts.

Examples of suitable alkylene oxides are tetrahydrofuran, propylene 1,2-oxide, butylene 1,2-oxide or butylene 2,3-oxide, styrene oxide, and preferably ethylene oxide and propylene 1,2-oxide. The alkylene oxides can be used individually, in alternating succession, or as a mixture.

Examples of starter molecules that can be used are: water, organic dicarboxylic acids, such as succinic acid, adipic acid, phthalic acid, and terephthalic acid, aliphatic and aromatic, optionally N-mono-, N,N-, and N,N′-dialkyl-substituted diamines having from 1 to 4 carbon atoms in the alkyl radical, e.g. optionally mono- and dialkyl-substituted ethylenediamine, diethylenetriamine, triethylenetetramine, 1,3-propylenediamine, 1,3- or 1,4-butylenediamine, 1,2-, 1,3-, 1,4-, 1,5-, and 1,6-hexamethylenediamine, phenylenediamines, 2,3-, 2,4-, and 2,6-tolylenediamine, and 4,4′-, 2,4′-, and 2,2′-diaminodiphenylmethane.

Polyester polyols can by way of example be produced from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of mixtures, e.g. in the form of a mixture of succinic, glutaric, and adipic acid. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol, triols having from 3 to 6 carbon atoms, e.g. glycerol and trimethylolpropane, and, as higher-functionality alcohol, pentaerythritol. The polyhydric alcohols can be used alone or optionally in mixtures with one another, in accordance with the properties desired.

The amount of polyether polyol and/or polyester polyol, based on the total weight of the resin components, is preferably from 0 to 40% by weight, particularly preferably from 15 to 35% by weight.

Chain Extender and/or Crosslinking Agent (c)

Chain extenders and/or crosslinking agents (c) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g. ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g. 1,2,4- or 1,3,5-trihydroxycyclohexane, glycerol, and trimethylolpropane.

The amount of chain extender and/or crosslinking agent c), if present, is preferably from 0 to 50% by weight, particularly preferably from 10 to 40% by weight, based on the total weight of the resin components.

Flame Retardant (d)

Flame retardants (d) that can be used are solid flame retardants, liquid flame retardants or the combination thereof, such as melamine, expandable graphite (EG), red phosphorus, ammonium polyphosphate, tris(1-chloro-2-propyl) phosphate (TCPP), triethyl phosphate (TEP).

For the purpose of flame resistance, the total amount of flame retardants is preferably in the range of 5 to 30 wt %, more preferably 10 to 25 wt %, based on the total weight of the resin components.

Filler (e)

Fillers that can be used are the usual organic or inorganic fillers known per se. Individual examples which may be mentioned are: inorganic fillers, such as silicate minerals, metal oxides, such as aluminas, titanium oxides and iron oxides, and also polyamide fibers, polyacrylonitrile fibers, polyurethane fibers, and polyester fibers. Preference is given to the use of mineral powders or glass/carbon fiber.

The amount of filler is from 5 to 30% by weight, preferably from 10 to 25% by weight, based on the total weight of the resin components. The weight ratio of flame retardant (d) and filler (e) is in a range of from 0.1 to 10, preferably 0.5 to 2.

The fillers may serve to reduce the coefficient of thermal expansion of the polyurethane foam, which is greater than that of metal, for example, and thus to match this coefficient to that of the metal. This is particularly advantageous for a durably strong bond between metal sheets and polyurethane core layer, since it results in lower stresses between the layers when they are subjected to thermal load.

Blowing Agent (f)

The blowing agent (f) used according to the invention preferably comprises water. The blowing agent (f) used can also comprise, as well as water, other chemical and/or physical blowing agents in the art. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, e.g. perfluorohexane, fluorochlorocarbons, and ethers, esters, ketones and/or acetals. In one preferred embodiment, water is used as sole blowing agent (f). In this case, the polyurethane foam according to the invention is water-blown polyurethane spray foam. Concerning water, there is no particular limitation. Mineral water, deionized water or tapwater can be used.

The amount of blowing agent is from 0 to 5% by weight, preferably from 0.1 to 3% by weight, based on the total weight of the resin components.

Catalyst (g)

As catalyst (g), it is possible to use all compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, e.g. bismuth(III) neodecanoate, bismuth 2-ethylhexanoate and bismuth octanoate, or alkali metal salts of carboxylic acids, e.g. potassium acetate or potassium formate.

Preference is given to using amine-based catalysts as catalyst (g), such as N,N,N′,N′-tetramethyldipropylenetriamine, 2-[2-(dimethylamino)ethyl-methylamino]ethanol, N,N,N′-trimethyl-N′-2-hydroxyethyl-bis-(aminoethyl)ether, bis(2-dimethylaminoethyl) ether, N,N,N,N,N-pentamethyldiethylenetriamine, N,N,N-triethylaminoethoxyethanol, dimethylcyclohexylamine, trimethyl hydroxyethyl ethylenediamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene. Here, examples which may be mentioned are Jeffcat ZF10 (CAS No. 83016-70-0), Jeffcat DMEA (CAS No. 108-01-0) and Dabco T (CAS No. 2212-32-0). This kind of reactive catalyst has an effect of reducing VOC value.

The amount of catalyst (g), based on the total weight of the resin components, is preferably from 0.1 to 5% by weight, particularly preferably from 0.1 to 3.5% by weight.

Additives and/or Auxiliaries (h)

Additives and/or auxiliaries (h) that can be used comprise surfactants, preservatives, colorants, antioxidants, reinforcing agents, stabilizers, and water absorbent. In preparing polyurethane foam, it is generally highly preferred to employ a minor amount of a surfactant to stabilize the foaming reaction mixture until it cures. Such surfactants advantageously comprise a liquid or solid organosilicone surfactant, which is employed in amounts sufficient to stabilize the foaming reaction mixture. Typically, the amount of auxiliaries, especially surfactants, is preferably from 0 to 15% by weight, more preferably from 0.5 to 6% by weight, based on the total weight of the resin components.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes” ], Carl Hanser Verlag, 3rd edition 1993, chapter 3.4.

The weight ratio of resin components and isocyanate component is in a range of from 1:0.6 to 1:1.2, preferably 1:0.7 to 1:1.

Polyamide Nylon

In a further embodiment, the present invention also encompasses polyamide nylon produced via reaction injection molding of lactam. In preparing a polyamide nylon, “molten lactam containing an alkali catalyst” and “molten lactam containing a cocatalyst” are mixed and injected into a mold.

As the lactam to be subjected to the polymerization, there can be mentioned, for example, γ-butyrolactam, δ-valerolactam, ε-caprolactam, ω-enantholactam, ω-capryl lactam, ω-undecanolactam and w-lauryl lactam. These lactams may be used alone or in the form of a mixture of two or more of them.

As the alkali catalyst, there can be used all of compounds used in the known methods of the alkali polymerization of lactams. For example, there can be mentioned alkali metals and alkaline earth metals, their hydrides, oxides, hydroxides, carbonates, alkylated products, alkoxides and grignard compounds, sodium naphthalene. It is preferred that the alkali catalyst be used in an amount of 0.05 to 10 mole %, more preferably 0.2 to 5 mole %, based on the lactam.

All of cocatalysts used in the known alkali polymerization methods can be used in the present invention. For example, there can be mentioned N-acyl lactams, organic isocyanates, acid chlorides, acid anhydrides, esters, urea derivatives, carbodiimides and ketenes. The cocatalysts are used in an amount of 0.01 to 5 mole % based on the lactam.

In the present invention, the polymerization of a lactam may be carried out in the presence of a plasticizer, a filler, a fiber, a blowing agent, a dye, a pigment or a stabilizer such as an antioxidant, which does not substantially inhibit the polymerization reaction. N-alkylpyrrolidone or dialkylimidazolidinone is preferred as the plasticizer, and the plasticizer is used in an amount of 2 to 25% by weight based on the lactam. As the filler, there can be mentioned calcium carbonate, wollastonite, kaolin, graphite, gypsum, feldspar, mica, asbestos, carbon black and molybdenum disulfide. As the fiber, there can be mentioned glass fiber such as milled glass (pulverized glass), graphite fiber, mineral fiber, and steel fiber. The filler may be used in an amount of 2 to 50% by weight based on the lactam. As the blowing agent, benzene, toluene and xylene are preferably used, and the amount thereof is 1 to 15% by weight based on the lactam.

Unsaturated Polyester Resin

In a further embodiment, the present invention also encompasses unsaturated polyester resin produced via reaction injection molding. In preparing a polyester resin, component A, “a major base mass of polyester resin in fluid form, at least one polyester cure accelerator comprising organic hydroperoxide, and an additive highly exothermically reactive with isocyanate”, and Component B, “organic isocyanate and surfactant”, are mixed and injected into a mold. The heat from the highly exothermic reaction of the additive almost immediately triggers and accelerates the isocyanate and organic hydroperoxide gas-evolving reaction. The gas evolved expands the resin mass to fill the mold cavity under pressure, while continued heat generation causes the polyester cure accelerator to react to cure the polyester in the fully expanded state.

The unsaturated polyester resin which constitutes most of Component A may be prepared by the condensation of an unsaturated dicarboxylic acid, such as maleic or fumaric acid, with a glycol or mixture of glycols, such as ethylene glycol, propylene glycol, 1,4-butanediol, 1,6-hexandiol or diethylene glycol.

Organic hydroperoxide is t-butyl hydroperoxide which reacts with the organic isocyanate to generate carbon dioxide, and which, at elevated temperatures, reacts to cure the polyester resin. This particular organic hydroperoxide is substantially unreactive with the resin at room temperature, typically having a shelf life of twenty hours, which may be extended with inhibitors, e.g. hydroquinone, and is therefore introduced into the system in component A with the resin and the additive. In RRIM (Reinforced Reaction Injection Molding) processes, reinforcing fibers are also introduced into the mixture with this component.

The additive highly exothermically reactive with isocyanate can be a tertiary amine.

Component B for the expansion of an unsaturated polyester resin is preferably comprised of a mixture of the reactive organic isocyanate and a surfactant.

Organic isocyanate is reactive, upon mixing, with an ingredient of Component A to evolve carbon dioxide gas within the resin mass. Examples of suitable isocyanates are aromatic isocyanates or aliphatic isocyanates, such as n-butyl isocyanate, phenyl isocyanate, tolylene diisocyanates, diphenyl methane diisocyanates, napthalene diisocyanates, triphenylmethane triisocyanates and polymeric polyisocyanates.

The surfactant, which is used to control the size distribution of cell-forming bubbles, can be any suitable agent (preferably non-ionic) that adjusts the surface tension to promote the desired cell formation when organic hydroperoxide is reacted with the isocyanate. Preferably a silicone such as a polyoxyalkylene polysiloxane polymer is employed.

Epoxy Resin

In a further embodiment, the present invention also encompasses epoxy resin produced via reaction injection molding, wherein component A, “epoxy resin, glycidyl methacrylate and a vinyl ester”, and component B, “curing agent, curing accelerator and a radical polymerization initiator”, are mixed and injected into a mold.

The epoxy resins are those having two or more epoxy groups. It is preferred to use epoxy resins which are liquid at room temperature.

Glycidyl methacrylate has the following functions. Firstly, it lowers the viscosity of the whole composition. Secondly, since it has both an epoxy group and a methacrylate group, it functions as a crosslinking agent between the polymerization network of the epoxy resin and vinyl ester, whereby the structure of the resulting cured product can be made more uniform. It is preferred to premix the glycidyl methacrylate with the epoxy resin.

The vinyl ester serves to accelerate the curing reaction. The epoxy resin has a disadvantage in that curing time in the reaction injection molding is long. However, when the radical polymerization of the vinyl ester is allowed to proceed simultaneously, the curing reaction of the epoxy resin seems to be accelerated. Vinyl esters having an acrylic ester structure are preferred from the view point of reaction rate.

The curing agent for the epoxy resin, which is used in the present invention, is mainly reacted with the epoxy resin and glycidyl methacrylate to accelerate the formation of the polymerization network of the epoxy resin. The curing agent can be chosen from among conventional curing agents, such as polyamines, polyamides, dibasic acids and dibasic acid anhydrides, depending upon the intended purposes, reaction rate and the desired physical properties of the cured products.

The curing accelerator has the effect of accelerating initiating and carrying out the curing reaction. The curing accelerator can be chosen from tertiary amines, imidazoles, phenols, organometallic compounds and/or inorganic metallic compounds.

The radical polymerization initiator used in the present invention generates a radical by heating and functions as a polymerization initiator for glycidyl methacrylate and the vinyl ester. Organic peroxides conventionally used as initiators are preferred. Examples of organic peroxides include t-butyl hydroperoxide, cumene hydroperoxide, di-t-butyl peroxide, dicumyl peroxide, lauroyl peroxide, benzoyl peroxide and t-butyl peroxybenzoate.

Phenolic Resin

In a further embodiment, the present invention also encompasses phenolic resin produced via reaction injection molding, wherein “phenolic composition and surfactant” and “blowing agent and initiator” are mixed and injected into a mold.

The phenolic composition can be liquid phenolic composition known in the art, which has low enough viscosity for reaction injection molding process.

The surfactant is selected from the group consisting of polyvinyl chloride/polyethylene oxide, ethoxylated castor oil, block copolymer of ethylene oxide/propylene oxide.

The blowing agent is selected from the group consisting of CFCS series, HCFC series and alkanes blowing agent.

The initiator is selected from the group consisting of inorganic acid such as sulfuric acid, hydrochloric acid, nitric acid, phosphoric acid; organic acid such as benzene sulfonic acid, toluenesulfonic acid, phenolsulfonic acid, xylene monosulfonic acid, naphthalene sulfonic acids.

Process for Producing the Battery Pack

In another aspect, the present invention further provides a process for producing the battery pack according to the invention, comprising the following steps:
providing upper cover via reaction injection molding (RIM), and
providing bottom tray, comprising the steps of
   1) bending flat metal sheets into target 3D shape top and bottom metal face sheets and welding at the open corner;
   2) fixing top and bottom metal face sheets into a RIM mold, and then closing the mold;
   3) injecting the reactants into the hollow space cavity between metal face sheets to form molded core layer via reaction injection molding;
   4) demolding and optionally trimming.

For thin steel sheet (<0.3 mm), it was found that stamping steel sheet with a small curvature radius (example ≤10 mm) will lead to a certain degree of crack defect at the corners. To avoid such crack defect, the stamping curvature radius must be bigger than 50 mm. But in such a design, it will greatly influence the inner space efficiency of the battery pack, and hence cause negative impact on the battery pack energy density. To overcome this problem, bending/welding process is used to replace conventional stamping process.

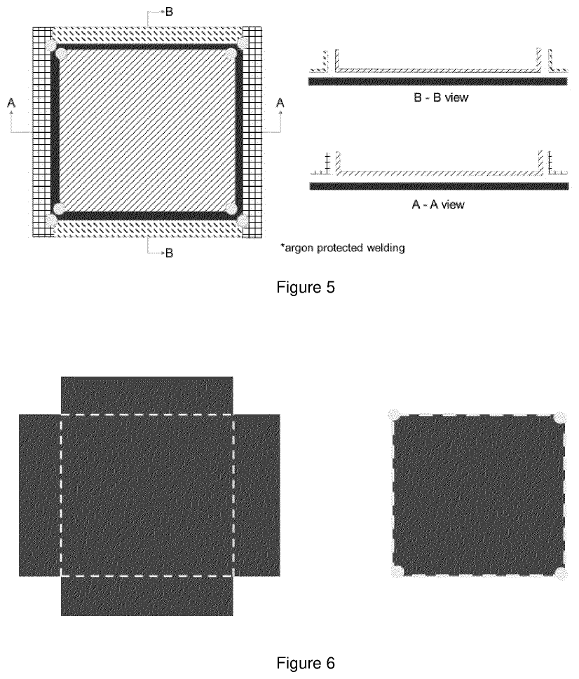

According to the invention, during the step 1), the flat metal sheet is firstly cut into a predetermined shape, then bent into the target 3D shape, and finally welded at the open corner. As indicated in FIGS. 5-6, a flat 1 m×1 m metal sheet has 0.1 m×0.1 m squares cut from its four corners, and then the cut metal sheet is bent along the bending line (i.e., dashed lines) at an angle of from 80° to 100°, preferably 90°, to obtain open box shape. The flat metal sheet can be firstly cut into a predetermined shape via a laser beam machine. Bending metal sheet is conventionally accomplished by using either hand tools or bending machines including press and box brakes. The obtained 3D shape is finally welded, e.g., argon arc welded. Argon arc welding is a welding technique that uses argon gas as a shielding gas, also known as argon gas shielded welding. Argon gas is passed around the arc welding to isolate the air from the welding zone and prevent oxidation of the welding zone.

By using the bending/welding process, the steel sheet has intact four sharp corners with very small curvature radius and is convenient for subsequent RIM process.

Preferably, the step 2) comprises putting 3D shape top and bottom metal face sheets into a RIM mold, sucking the metal face sheets onto RIM mold tightly by vacuuming air or magnetic beneath the metal face sheets, and then placing spacers between the metal face sheets and closing the mold. The closed mold is vacuumed to assist the reactants of core layer fill up the long and thin cavity of mold.

In step 2), the metal face sheets are preferably pretreated by etching, primer, plasma, laser or adhesive on the side facing the core layer to enhance the adhesion force to the core layer

The step 3) is a step of injecting into the RIM mold cavity the reactants through an inlet of the mold until the reactants fill up the mold and then reaction curing the reactants by maintaining the temperature to form core layer. The temperature maintained for the reaction curing is 45° C. to 80° C., and the time for the reaction curing is 1 to 10 minutes.

The viscosity of the reactants is 100-1000 mPa·s.

Preferably, the mold is provided with a heating device and before step 3), the mold is pre-heated to 45° C.-80° C.

The core layer can be a rigid foam or compact substance which generally completely fills the hollow space. The process of the invention makes economical production of cover parts for battery pack with a short cycle time.

### Example

The present invention will now be described with reference to Examples and Comparative Examples, which are not intended to limit the present invention.

The following starting materials were used:
A component (polyol component)
   Polyether polyol:
high reactive trifunctional polyether polyol containing primary hydroxyl, commercially available under trade name LUPRANOL® 2095 from BASF, OH number: 28-35 mg KOH/g; Molecular weight: 3000-6000
   Polyester polyol:
aromatic polyester polyol, commercially available under trade name LUPRAPHEN 3905 from BASF, OH number: 175-310 mg KOH/g; Molecular weight: 350-650
   Water absorbent:
Molecular sieve, 4 A
   Surfactant:
silicone surfactant commercially available as ORTEGOL 501 from Evonik
   Solid flame retardant:
expandable graphite (EG) from Sigma-Aldrich, 80 mesh
   liquid flame retardant:
tris(1-chloro-2-propyl) phosphate (TCPP), CAS No: 13674-84-5, commercially available from Albright and Wilson Ltd.
   Filler
glass fibers powders, filament diameter: 9-20 μm, Fiber length: <1000 μm.
   Catalyst,
amine catalyst, CAS No: 83016-70-0, commercially available under trade name JEFFCAT ZF10 from Huntsman
   Blowing agent: Deionized water
   Chain extender: Dipropylene glycol (DPG)
B component (isocyanate component)
   Isocyanate:
PMDI, commercially available under trade name ISOCYANATE B1001 from BASF

The following methods were used to determine properties:
Density in kg/m³: GB/T 6343-2008
Flammability G 8410-2006
Bending stiffness, in KN/mm2: ASTM D7250-20
External fire burning test: GB 38031-2020
   Test method: (8.2.7.1)
      Ignite the fuel Pan from distance 3 m from the target
      Pre-heat the fire for 60 s
      Move the fuel pan under the battery pack
      Directly expose the battery pack to fire for 70 s
      Add a cover on the fuel pan, and continue the test for 60 s
      Remove the fuel pan
      Observe the battery pack for 2 hrs.
   Requirement: (5.2.7)
      The battery pack should not explode
      Nickle hydrogen battery not applied

### Example 1—Premixing of Resin Component and Isocyanate Component

The resin component and isocyanate component were formulated according to table 1, and then put into polyol tank and iso tank for subsequent reaction injection molding. The viscosity of the two-component reactive system for polyurethane molded product was 100-1000 mPa·s under the reaction condition described herein.

TABLE 1
resin component

| | | Content |
|---|---|---|
| 1 | Polyether polyol, LUPRANOL 2095 | 18.2 |
| 2 | Polyester polyol, LUPRAPHEN 3905 | 12 |
| 3 | Chain extender, Dipropylene glycol | 24 |
| 4 | Flame retardant, expandable graphite and TCPP | 20 |
| 5 | Filler, glass fibers powder | 20 |
| 6 | Blowing agent, water | 0.2 |
| 7 | Catalyst, JEFFCAT ZF10 | 0.1 |
| 8 | Water absorber, molecular sieve | 0.5 |
| 9 | silicone surfactant, ORTEGOL 501 | 5 |
| | Total | 100 |

isocyanate component

| | | |
|---|---|---|
| 1 | PMDI | 73.64 |

### Example 2—Preparing Sandwich Bottom Tray

A bottom tray according to the present invention was produced by a process comprising the following steps.
S101: bending metal sheets SUS 304 having a thickness of about 0.3 mm into the target 3D shape top and bottom metal face sheets at an angle of about 90°, and welding at the open corner by argon arc welding;
S102: putting top and bottom steel face sheets into a RIM mold;
S103: sucking the steel sheets onto mold tightly by vacuuming air beneath the steel sheets, and then placing spacers between the steel sheets and closing the mold;
S104: preheating the mold to a temperature of 50° C.;
S105: injecting a polyurethane-synthesizing material for forming polyurethane core layer into the mold through the injection inlet of the mold, until the polyurethane-synthesizing material fills up the mold, wherein the temperature of the polyurethane-synthesizing material is 50° C., and then reaction curing the polyurethane-synthesizing material by maintaining the temperature at 80° C. for 5 minutes (RIM process);
S106: after cooling for 7 minutes, opening the mold and removing the molded bottom tray, wherein the core layer of the molded tray is the polyurethane layer having a thickness of about 2 mm and a density of about 1000 kg/m³, with the steel face sheets on both sides of the polyurethane core layer.

The obtained bottom tray showed weight reduced by about 40%, bending stiffness of about 200,000 KN/mm2, higher than that of a pure steel stamping sheet with thickness equal to or above 2.5 mm.

### Example 3—Preparing Upper Cover

In a similar manner, an upper cover having rib pattern according to the present invention was also produced by Reaction Injection Molding process.

Finally, the upper cover, battery module and the bottom tray were sealed with flange and it successfully passed fire burning test.

a. Sandwich Structure of Bottom Tray to Impart Weight Reduction

The inventors tested the weight and bending stiffness of steel sheet, aluminum sheet and several sandwich bottom trays. Inventive bottom trays were prepared according to the procedure stated above for Example 2 except that the thicknesses of core and facer were altered as shown in the following Table 2.

TABLE 2

| | | Inventive | Inventive | Inventive | Inventive | Inventive | Inventive |
|---|---|---|---|---|---|---|---|
| | 1.2 mm | sandwich | sandwich | sandwich | sandwich | sandwich | sandwich |
| | steel sheet | bottom | bottom | bottom | bottom | bottom | bottom |
| | (comparative) | tray 1 | tray 2 | tray 3 | tray 4 | tray 5 | tray 6 |
| Total thickness, mm | | 4 | 3.5 | 3 | 2.5 | 2 | 1.5 |
| Core thickness, mm | | 3.836 | 3.25 | 2.666 | 2.08 | 1.496 | 0.912 |
| Facer thickness, mm | | 0.082 | 0.125 | 0.167 | 0.21 | 0.252 | 0.294 |
| Weight, kg | 21.4 | 12.8 | 12.8 | 12.8 | 12.8 | 12.8 | 12.8 |
| Bending stiffness, | 51,800 | 297,000 | 270,800 | 249,500 | 202,600 | 141,000 | 78,800 |
| KN · m/m2 | | | | | | | |

It can be seen from the Table 2 that, by using sandwich bottom trays comprising polyurethane core layer, the weight of bottom tray can be reduced by about 40%, and the Max. stiffness at specified part thickness can be improved significantly.

b. New Design for 3D Metal Sheet of Bottom Tray (Use Bending/Welding to Replace Stamping)

The inventors found that cracks were formed at the corners of thin steel sheet (<0.3 mm) during the process of stamping steel sheet with a small curvature radius (example ≤10 mm) of bottom tray. To avoid such crack defect, the stamping curvature radius must be bigger than 50 mm. But in such a design, it will greatly influence the inner space efficiency of the battery pack, and hence cause negative impact to the battery pack energy density. In view of this, the inventors used bending/welding process to replace conventional stamping process.

Flat metal sheet SUS 304 having a size of about 1 mxl m×0.3 mm was firstly cut into a predetermined shape as shown in FIG. 6 via a laser beam machine, then bent along the bending lines at an angle of about 90°, to obtain the target open box shape, and finally welded at the open corner by argon arc welding. It was found that the 3D shape steel sheet had intact four sharp corners with very small curvature radius and is convenient for subsequent RIM process.

The metal sheet of the bottom tray further had wavy surface to protect penetration from outer force.

c. Rib Effect of Upper Cover to Improve Parts Stiffness/Reduce Weight

The inventors conducted another experiment to obtain upper cover with various rib pattern design. All the procedures were repeated according to example 3 except that rib height was altered as shown in the following Table 3.

TABLE 3

| Thickness | Rib Height | Max Displacement | Weight | Weight |
|---|---|---|---|---|
| (mm) | (mm) | in Z Dir. (mm) | (kg) | Difference |
| 2.5 | / | −27.81 | 6.54 | 1 |
| | 3 | −19.18 | 6.65 | 1.7% |
| | 5 | −16.56 | 6.68 | 2.1% |
| | 8 | −13.20 | 6.71 | 2.6% |
| 2 | 3 | −27.09 | 5.57 | −14.8% |
| | 5 | −22.86 | 5.59 | −14.5% |
| | 8 | −17.55 | 5.63 | −13.9% |
| 1.5 | 3 | −40.58 | 4.56 | −30.3% |
| | 5 | −33.15 | 4.59 | −29.8% |
| | 8 | −24.05 | 4.62 | −29.4% |

It was surprisingly found that RIM process can easily realize complex (especially deep) rib pattern design, whereas it is difficult for some other processes such as thermal forming and cold forming (stamping). It can be seen from Table 3 that, with the rib height of polyurethane upper cover increasing from 3 mm to 8 mm, the Max. Displacement in Z direction was reduced by 60%-70%, implying that the parts stiffness was improved significantly.

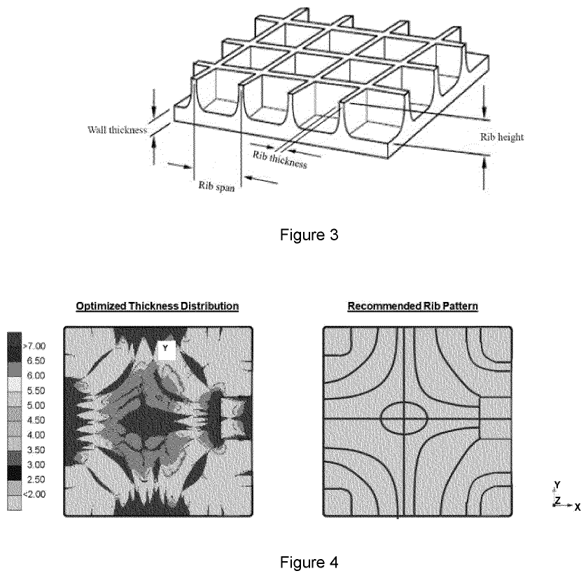

Thus, even though RIM part has intrinsically low stiffness due to limited filler content (up to 20%), rib pattern design can effectively increase the parts stiffness. FIGS. 3-4 showed the recommended rib pattern of upper cover.

d. Water Immersion Safety

According to new standard GB 38031-2020 for water immersion safety, IPX7, the required water immersion safety is much higher than before. Up to now, flat gasket and sealing design is suitable for metal housing, not suitable for plastic.

The inventors found that groove sealing design can meet the requirement for water immersion safety.

The bottom tray produced according to example 2 and the upper cover produced according to example 3 were sealed with flange, with gasket groove having a depth of 7 mm and width of 3.5 mm on plastic flange, and vertical oval shape AEM gasket (shore A hardness of 50) having a height of 9 mm and width 2.5 mm located partly in the groove. AEM gasket had micro lips on both top and bottom side of gasket. After the screws were tightened to secure the upper cover and the bottom tray together, the gasket was compressed within the groove to form a seal there-between. This sealing design shows better sealing performance and is critical for the water tightness of battery pack.

The groove sealing design was repeated according to the above procedures except that the depth and width of the groove were 8 mm and 4 mm, respectively, and the height and width of AEM gasket were 10 mm and 3 mm, respectively. The result showed good sealing performance as well.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A covering article comprising a reaction injection molded product as core layer and two metal sheets located on both sides of the core layer, wherein the covering article is a 3D shape article.

2. The covering article according to claim 1, wherein the reaction injection molded product is selected from the group consisting of polyurethane, polyamide, unsaturated polyester resin, epoxy resin, and phenol-formaldehyde resin.

3. The covering article according to claim 1, wherein the metal sheets are same or different material selected from the group consisting of aluminum alloy, iron, steel, and aluminum.

4. The covering article according to claim 1, wherein the metal sheets have four sides bent at an angle of from 800 to 100°, and then the open corners are joined by welding.

5. The covering article according to claim 4, wherein the curvature radius of bending angle is in the range from 0 to 10 mm.

6. The covering article according to claim 1, wherein the metal sheets have a thickness between 0.08 and 0.6 mm.

7. The covering article according to claim 1, wherein the core layer has a thickness between 0.8 and 5 mm, and a density between 600 and 2000 kg/m³.

8. The covering article according to claim 1, wherein the covering article is prepared by the following steps:
1) bending flat metal sheets into target 3D shape top and bottom metal face sheets and welding at the open corner;
2) fixing top and bottom metal face sheets into a mold;
3) injecting the reactants into the hollow space cavity between metal face sheets to form molded core layer via reaction injection molding; and
4) demolding and optionally trimming.

9. A method of using the covering article according to claim 1, the method comprising using the covering article as a bottom tray of a battery pack.

10. A battery pack, comprising
an upper cover; and
a bottom tray, wherein the bottom tray is the covering article according to claim 1.

11. The battery pack according to claim 10, wherein the upper cover is a reaction injection molded product selected from the group consisting of polyurethane, polyamide, unsaturated polyester resin, epoxy resin, and phenol-formaldehyde resin.

12. The battery pack according to claim 10, wherein the upper cover is provided with rib pattern.

13. The battery pack according to claim 12, wherein the rib height is in the range from 3 mm to 30 mm.

14. The battery pack according to claim 10, wherein the total thickness of upper cover is in the range from 1 to 5 mm, and the total thickness of bottom tray is in the range from 1 to 5 mm.

15. The battery pack according to claim 10, wherein the metal sheet of the bottom tray has wavy surface.

16. The battery pack according to claim 10, wherein the upper cover and the bottom tray are sealed with groove on flange, and vertical oval shape gasket in the groove.

17. The battery pack according to claim 16, wherein the gasket has micro lips on both top and bottom side of gasket.

18. The battery pack according to claim 16, wherein the depth of the groove is in the range of from 5 mm to 10 mm.

19. The battery pack according to claim 16, wherein the gasket material is selected from the group consisting of polyurethane foam, ethylene acrylic rubber (AEM), acrylate material (ACM), nitrile butadiene rubber (NBR), fluorocarbon rubber (FPM), ethylene propylene diene rubber (EPDM), hydrogenated acrylonitrile butadiene rubber (HNBR), methyl-vinyl silicone rubber (MVQ), silicone and fluorosilicone.

20. The battery pack according to claim 11, wherein a two-component reactive system for polyurethane molded product comprises
an isocyanate component consisting of
a) at least one isocyanate, and
resin components consisting of
b) at least one substance reactive toward isocyanate,
c) optionally chain extender and/or crosslinking agent,
d) flame retardant,
e) filler,
f) blowing agent, and
g) catalysts, and optionally
h) additives and/or auxiliaries,
wherein the flame retardant (d) is selected from the group consisting of expandable graphite, red phosphorus, ammonium polyphosphate, melamine, triethyl phosphate and tris(2-chloroisopropyl)phosphate, and the filler (e) is selected from the group consisting of mineral powders, glass fiber powders and carbon fiber powders.

21. The battery pack according to claim 20, wherein the weight ratio of resin components and isocyanate component is in a range of from 1:0.6 to 1:1.2.

22. The battery pack according to claim 20, wherein the weight ratio of flame retardant (d) and filler (e) is in a range of from 5 to 30.

23. The battery pack according to claim 20, which comprises, each based on the total weight of resin components (b)-(h),
b) 0-40 wt % of at least one substance reactive toward isocyanate,
c) 0-50 wt % of optionally chain extender and/or crosslinking agent,
d) 5-30 wt % of flame retardant,
e) 5-30 wt % of filler,
f) 0-5 wt % of blowing agent,
g) 0.1-5 wt % of catalyst, and optionally
h) 0-15 wt % of additives and/or auxiliaries.

24. The battery pack according to claim 10, which further comprises cell modules, cell controller for sensing and balancing, high-voltage connector, bus bar and battery controller.

25. The battery pack according to claim 10, which comprises PU pultrusion beam inside the battery pack as structural stiffener, or outside the battery pack as intrusion resistance reinforcement.

26. A process for producing the battery pack according to claim 10, comprising the following steps:
providing upper cover via reaction injection molding, and
providing bottom tray, comprising the steps of
1) bending flat metal sheets into target 3D shape top and bottom metal face sheets and welding at the open corner;
2) fixing top and bottom metal face sheets into a RIM mold;
3) injecting the reactants into the hollow space cavity between metal face sheets to form molded core layer via reaction injection molding; and
4) demolding and optionally trimming.

27. The process according to claim 26, wherein the step 2) comprises
putting top and bottom metal face sheets into a RIM mold;
sucking the metal face sheets onto the mold tightly by vacuuming air or magnetic beneath the metal face sheets, and then placing spacers between the metal face sheets and closing the mold.

28. The process according to claim 26, wherein in step 2), the metal face sheets are pretreated by etching, primer, plasma, laser or adhesive on the side facing the core layer.

29. The process according to claim 27, wherein in step 2), the closed mold is vacuumed to assist the reactants of core layer fill up the long and thin cavity of mold.

30. The process according to claim 26, wherein the step 3) is a step of injecting into the mold the reactants through an inlet of the mold until the reactants fill up the mold and then reaction curing the reactants by maintaining the temperature to form core layer.

31. The process according to claim 30, wherein the temperature maintained for the reaction curing is in a range of from 45° C. to 80° C., and the time for the reaction curing is in a range of from 1 to 10 minutes.

32. The process according to claim 30, wherein the viscosity of the reactants is in a range of from 100 to 1000 mPa·s.

33. The process according to claim 26, wherein the mold is provided with a heating device and before step 3), the mold is pre-heated to the temperature in a range of from 45° C.-80° C.
